(19) United States
(12) Patent Application Publication
(10) Pub. No.: US 2011/0232122 A1
(43) Pub. Date: Sep. 29, 2011

(54) DRYING AND WARMING APPARATUS AND METHOD

(76) Inventors: Matthew G. BUTLER, Little Silver, NJ (US); Tara A. BUTLER, Little Silver, NJ (US)

(21) Appl. No.: 12/749,283

(22) Filed: Mar. 29, 2010

(51) Int. Cl. F26B 5/00; F26B 3/02

(52) U.S. Cl. 34/282; 34/90

(57) ABSTRACT

A drying and warming apparatus is provided, comprising a table top having a substantially horizontal planar surface, a top side, and a bottom side; a fan assembly means adjacent the bottom side of the table top; a heating element adjacent the fan assembly; a casing comprising a top portion attached to the bottom side of the table top, a bottom portion remote from the top portion, and a wall vertically extending between the top and bottom portions, the casing arranged substantially perpendicular to the table top and extending downwardly from the bottom side of the table top to substantially encase the fan assembly means; a drying rack adjacent the bottom portion of the casing, the drying rack comprising a frame and at least one drying rod transversely secured within the frame; and at least one support member for supporting the table top, fan assembly means, casing and drying rack.

### BACKGROUND

1. Field of the Invention

Embodiments of the present invention generally relate to a drying and warming apparatus and method. More specifically, embodiments of the present invention relate to a drying and warming apparatus integrated with furniture and a method for use thereof.

2. Description of Related Art

When conventional dryers are not available for use, drying wet items can be a difficult process. This is a problem faced by many individuals when traveling and staying in hotels and other lodging facilities. For example, when an individual is finished swimming in a hotel pool, his or her options for drying wet items such as towels and bathing suits, are limited. This problem not only affects individuals while traveling, it also affects individuals in their homes, apartments, college dormitories, residential pools, and the like. In order to dry items in situations like this, individuals often resort to hanging items over doors, shower rods, or balconies. Also, many lodging facilities encourage guests to reuse towels in the interest of saving the environment. As such, they are forced to hang them and wait for them to dry.

These drying techniques can be ineffective, time consuming, and can cause the buildup of mold. Drying wet items over a shower rod, for example, may take numerous hours. In addition, when wet items are hung in environments where the ambient air is stagnant, a stable microenvironment conducive to mold growth is created. Mold can present several health risks, including allergic reactions and respiratory problems. The buildup of mold can also produce an unpleasant odor. To reduce or prevent the mold issue but promote environmentally conscious behavior, wet items should be dried in an efficient ecologically sound manner. Absent a naturally occurring wind or breeze and possibly a natural heat source, an efficient steady stream of air and/or heat must be electro-mechanically produced.

One method of providing a steady stream of air and heat currently available is using a heating/blowing device, such as a hair dryer. This method is not efficient, however, because current hair dryer designs are incapable of providing a steady stream of air sufficiently large enough to cover most items. This method is also cumbersome and inconvenient for the user, requiring them to physically hold the hair dryer for an extended period of time. Several drying and warming apparatus designs have been developed in attempts to solve this problem, but they all have failed. Current drying apparatus designs are large and bulky. Because space is limited in many hotels and homes, it is impractical for individuals to use large and bulky drying apparatus designs in rooms of limited space, absent at least a second functionality of the apparatus. In addition, current drying apparatus designs lack the functionality of warming items.

Thus, there is a need for an improved drying and warming apparatus and method for drying and warming items in a confined space.

### SUMMARY

Embodiments of the present invention generally relate to a drying and warming apparatus and method. In accordance with one embodiment of the present invention, there is provided a drying and warming apparatus comprising: a table top having a substantially horizontal planar surface, a top side, and a bottom side; a fan assembly means adjacent the bottom side of the table top; a casing comprising a top portion attached to the bottom side of the table top, a bottom portion remote from the top portion, and a wall vertically extending between the top and bottom portions, the casing arranged substantially perpendicular to the table top and extending downwardly from the bottom side of the table top to substantially encase the fan assembly means; a drying rack adjacent the bottom portion of the casing, the drying rack comprising a frame and at least one drying rod transversely secured within the frame; and at least one support member for supporting the table top, fan assembly means, casing and drying rack.

In accordance with another embodiment of the present invention, there is provided drying and warming apparatus comprising: a table top having a substantially horizontal planar surface, a top side, and a bottom side; a heating element for providing heat, the heating element adjacent the bottom side of the table top; a casing comprising a top portion attached to the bottom side of the table top, a bottom portion remote from the top portion, and a wall vertically extending between the top and bottom portions, the casing arranged substantially perpendicular to the table top and extending downwardly from the bottom side of the table top to substantially encase the heating element; a drying rack adjacent the bottom portion of the casing, the drying rack comprising a frame and at least one drying rod transversely secured within the frame; and at least one support member for supporting the table top, heating element, casing and drying rack.

In accordance with yet another embodiment of the present invention, there is provided a method of drying items, comprising: providing a drying and warming apparatus comprising: a table top having a substantially horizontal planar surface, a table top side, and a bottom side; a fan assembly means adjacent the bottom side of the table top; a casing comprising a table top portion attached to the bottom side of the table top, a bottom portion remote from the table top portion, and a wall vertically extending between the table top and bottom portions, the casing arranged substantially perpendicular to the table top and extending downwardly from the bottom side of the table top to substantially encase and obscure from view the fan assembly means; a drying rack adjacent the bottom portion of the casing, the drying rack comprising a frame and at least one drying rod transversely secured within the frame; and at least one support member for supporting the table top, fan assembly means, casing and drying rack; opening the drying and warming apparatus; placing a wet item on the at least one drying rod; closing the drying and warming apparatus; activating the drying and warming apparatus; waiting for the item to dry; opening the drying and warming apparatus; and removing the item from the rods.

In accordance with yet another embodiment of the present invention, there is provided drying and warming apparatus comprising: a table top having a substantially horizontal planar surface, a top side, and a bottom side; a fan assembly means adjacent the bottom side of the table top; a heating element adjacent the fan assembly means positioned substantially below the fan assembly means; a casing comprising: a top portion attached to the bottom side of the table top; a bottom portion remote from the top portion; a wall vertically extending between the top and bottom portions; and at least one opening for providing air intake, the at least one opening positioned substantially toward the top portion of the casing where the casing is attached to the bottom side of the table top, wherein the casing is arranged substantially perpendicular to the table top and extending downwardly from the bottom side of the table top to substantially encase the fan assembly means and the heating element; a drying rack adjacent the bottom portion of the casing, the drying rack comprising a frame and at least one drying rod transversely secured within the frame; at least two drawer track assemblies, each assembly comprising at least first and second members, the first member attachable to the drying rack and the second member supportable substantially below the casing, wherein the second member is engaged with the first member for supporting the drying rack and for sliding movement relative to the first member, the assemblies supporting the drying rack on opposite sides thereof; a control unit positioned adjacent the table top substantially outside the table top, the control unit comprising a controller for controlling the fan assembly means and the heating element; and at least four support members for supporting the table top, fan assembly means, heating element, casing, drying rack, drawer track assemblies, and control unit.

### BRIEF DESCRIPTION OF THE DRAWINGS

So the manner in which the above-recited features of the present invention can be understood in detail, a more particular description of embodiments of the present invention, briefly summarized above, may be had by reference to embodiments, some of which are illustrated in the appended drawings. The appended drawings illustrate only typical embodiments of embodiments encompassed within the scope of the present invention, and, therefore, are not to be considered limiting, for the present invention may admit to other equally effective embodiments; wherein:

FIG. 1 illustrates a perspective front view of a drying and warming apparatus in accordance with one embodiment of the present invention;

FIG. 2 illustrates a perspective front view of a drying and warming apparatus showing an extended drying rack in accordance with one embodiment of the present invention;

FIG. 2a illustrates a perspective front view of a drying and warming apparatus showing two extended drying racks in accordance with one embodiment of the present invention;

FIG. 3 illustrates an exploded view of a drying and warming apparatus in accordance with another embodiment of the present invention;

FIG. 4 illustrates a top view of a drying and warming apparatus in accordance with another embodiment of the present invention;

FIG. 5 illustrates a perspective front view of a drying and warming apparatus including two fan assemblies in accordance with another embodiment of the present invention;

FIG. 6 illustrates a perspective front view of a drying and warming apparatus including a heating element in accordance with another embodiment of the present invention;

FIG. 7 illustrates a perspective front view of a drying and warming apparatus including a fan assembly means and a removable table top panel in accordance with another embodiment of the present invention;

FIG. 8 illustrates a perspective front view of a drying and warming apparatus including an extendable table top in accordance with another embodiment of the present invention;

FIG. 9 illustrates a perspective front view of a drying and warming apparatus including a tiltable table section in accordance with another embodiment of the present invention;

FIG. 10 illustrates a perspective front view of a drying and warming apparatus including detachably attachable support members in accordance with another embodiment of the present invention;

FIG. 10a illustrates a perspective side view of a drying and warming apparatus including two foldable sections in an open position in accordance with another embodiment of the present invention;

FIG. 10b illustrates a perspective side view of the drying and warming apparatus of FIG. 10a, including the two foldable sections in a closed position;

FIG. 11 illustrates a perspective front view of a drying and warming apparatus attachable to a wall structure in accordance with another embodiment of the present invention;

FIG. 11a illustrates a perspective front view of a drying and warming apparatus attachable to a wall structure in accordance with another embodiment of the present invention;

FIG. 11b illustrates a perspective front view of two drying and warming apparatus attachable to a wall structure in accordance with another embodiment of the present invention;

FIG. 11c illustrates a perspective side view of a drying and warming apparatus attachable to a wall structure in accordance with another embodiment of the present invention;

FIG. 12 illustrates a perspective front view of a drying and warming apparatus attachable to a wall structure and supportable by a support member in accordance with another embodiment of the present invention; and

FIG. 13 illustrates a flow chart of an exemplary method for drying items using a drying and warming apparatus in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

In the following detailed description, numerous specific details are set forth to provide an understanding of exemplary embodiments or other examples described herein. In other instances, well-known methods, procedures, and components have not been described in detail, so as to not obscure the following description. Further, the examples disclosed are for exemplary purposes only and other examples may be employed in lieu of, or in combination with, the examples disclosed.

As used herein, the term “items” and its variants are intended to cover any item that can absorb moisture or become wet. For example, “items” may include one or more shirts, pairs of pants, bathing suits, towels, hats, shoes, socks, belts, blankets, linens, textiles, articles of manufacture, solid compositions of matter, and the like.

As used herein, the term “attached” and its variants are intended to cover all forms of permanent attachment, detachable attachment, direct attachment, indirect attachment, and integration. For example, “attached” may include electrical attachment, mechanical attachment, magnetic attachment, and the like. In many embodiments of the present invention, mechanical attachment may include attachment via brackets, adhesive, Velcro®, snaps, buttons, latching apparatuses, and the like.

As used herein, the term “fan assembly” means and its variants are intended to cover all means of turbulent air generation. For example, “fan assembly” means may include an axial fan assembly, a radial fan assembly, a mixed flow fan assembly, a cross flow fan assembly, any turbulent air generation means that does not utilize a fan, any type of motor that could cause air to be blown over items, and the like.

As used herein, the term “table top” and its variants are intended to cover all surfaces capable of accepting items. For example, “table top” may include a table top, a shelf top, a chair top, a dresser top, a bureau top, an ottoman top, and the like.

Embodiments of the present invention generally relate to a drying and warming apparatus and method. More specifically, embodiments of the present invention relate to a drying and warming apparatus integrated with furniture and a method. In addition to its drying and warming capabilities, the apparatus may generally be aesthetically pleasing in that it can be furniture-grade look and quality, and utilitarian in that it may function as a table, a shelf, or both while in use and while not in use as a drying and warming apparatus.

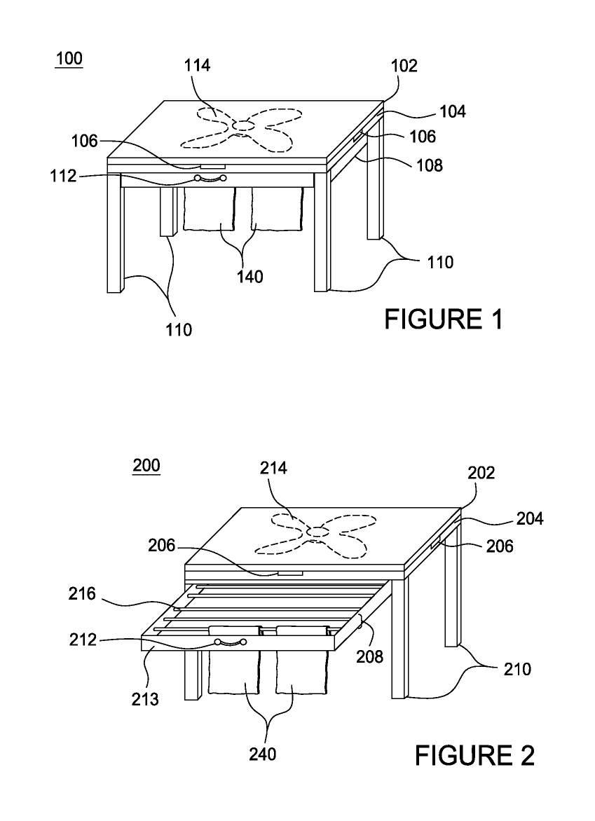

FIG. 1 illustrates a perspective front view of a drying and warming apparatus 100 in accordance with one embodiment of the present invention. Although depicted as comprising a table in FIG. 1, in alternative embodiments, the drying and warming apparatus 100 may comprise any type of furniture, for example, a pub table, dining table, billiard table, Murphy table, writing desk, bedside table, bistro table, card table, coffee table, console, davenport desk, dressing table, end table, escritoire, gateleg table, night table, occasional table, Pembroke table, roll-table top desk, tea table, trestle table, vanity table, work table, shelving unit, book case, counter, chair, dresser, armoire, bureau, bed, couch, loveseat, ottoman, and the like.

In one embodiment of the present invention, the drying and warming apparatus 100 comprises a table top 102, a casing 104, a drying rack 108, a fan assembly 114, and support members 110. The dimensions of the drying and warming apparatus 100 may comprise any size and shape contemplated within the scope of the embodiments of the present invention. In many embodiments of the present invention, the apparatus 100 may comprise any horizontal length and width dimensions, for example: 36″×36,″ 30″×18,″ 30″×10,″ 24″×12,″ and 24″×18.″ In accordance with one embodiment of the present invention, the table top 102, the casing 104, and the at least one support member 110 may comprise substantially the same material, wherein the material may be opaque for purposes of covering the fan assembly 114.

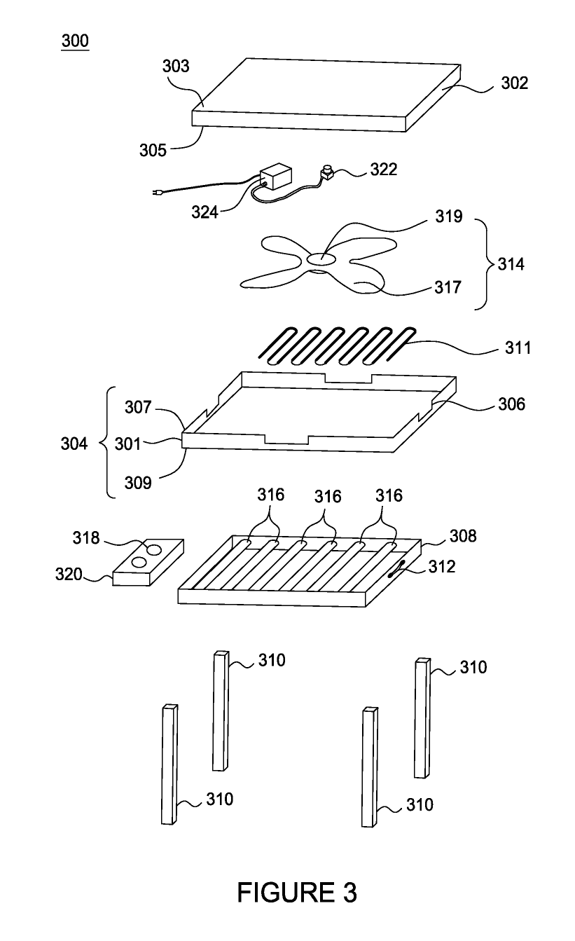

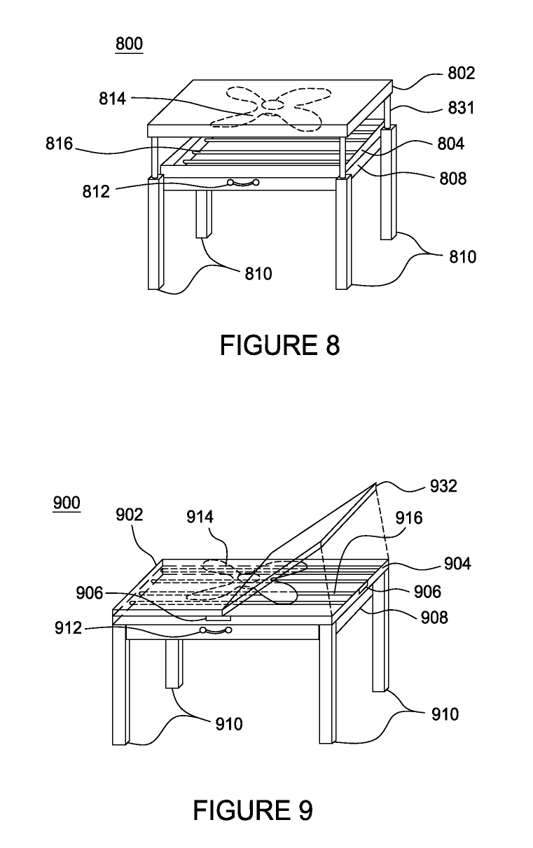

In one embodiment of the present invention, the table top 102 has a substantially horizontal planar surface, a top side, and a bottom side (see FIG. 3). The substantially horizontal planar surface may be parallel, for example, to a ground surface, a horizon line, or any other fixed or variable substantially horizontal plane. Although depicted in a rectangular shape, the table top 102, may comprise any surface capable of accepting items and may have any shape and size. For example, the shape of the table top 102 may be a parallelogram, a square, a triangle, a circle, an oval, an ellipse, and the like. In accordance with one embodiment of the present invention, the table top 102 may have sufficient thickness for allowing the table top 102 to accept items. In alternate embodiments of the present invention, the table top 102 or a portion thereof may be removably attached or permanently attached to the casing 104. The table top 102 may be of sufficient size to cover the casing 104 so items may not be dropped into the fan assembly 114 from above. The table top 102 may comprise, for example, any suitable material such as wood, plastic, metal, synthetic materials, glass, natural stone, marble, concrete, granite, bamboo, and the like. In accordance with other embodiments of the present invention, a portion of the table top 102 may be removed (see FIG. 7), raised (see FIG. 8), or tilted upward (see FIG. 9). In one embodiment of the present invention, the table top 102 may comprise the same material as the casing 104, wherein the material comprises any level of transparency from opaque to completely transparent. In accordance with another embodiment of the present invention, the table top 102 may further comprise an opening (not pictured) for receiving a picture, logo, text, or advertisement message.

In an alternative embodiment of the present invention, the table top 102 and the casing 104 may completely encase the fan assembly 114. The casing 104 may have at least one opening 106 for allowing sufficient air intake to displace air over items. The casing 104 may comprise for example, any suitable material such as wood, plastic, metal, synthetic materials, glass, natural stone, marble, concrete, granite, bamboo, and the like. In one embodiment of the present invention, the casing 104 may further comprise a material of sufficient strength to support the weight of a fan assembly 114 and a table top 102. The casing 104 may further comprise at least one opening 106 for providing air intake, the at least one opening 106 positioned toward the top portion of the casing where the casing is attached to the bottom side of the table top 102. In another embodiment of the present invention, the at least one opening 106 may be positioned on any portion of the casing. The at least one opening 106 may be of sufficient size to provide air intake to the fan assembly 114. In one embodiment of the present invention, casing 104 may be detachably attached to the drying and warming apparatus 100 for allowing access to the fan assembly 114 for cleaning. The casing 104 may have sufficient size to cover the drying rack 108.

In many embodiments of the present invention, the drying rack 108, the casing 104, and the table top 102 may be supported by the at least one support member 110. In many embodiments of the present invention, the at least one support member 110 may comprise at least one table leg of any size or shape. In another embodiment of the present invention, the table leg is attached to the casing 104. The at least one support member 110 may be made of material sufficient to support the weight of the drying rack 108, the casing 104, and the table top 102. The at least one support member 110 may comprise, for example, wood, plastic, metal, synthetic materials, glass, natural stone, marble, concrete, granite, bamboo, and the like. The at least one support member 110 is positioned substantially below the drying rack 108, and may be mounted to at least one of the drying rack 108, the casing 104, and the table top 102. In accordance with another embodiment of the present invention, the at least one support member 110 may be detachably attached to at least one of the drying rack 108, the casing 104, and the table top 102. In another embodiment of the present invention, the at least one support member 110 may be collapsible. In accordance with another embodiment of the present invention, the at least one support member may fold in half, enabling storage of the drying and warming apparatus. In another embodiment of the present invention, the at least one support member 110 may comprise a wall mounting unit attached to the casing. In yet another embodiment of the present invention, the at least one support member 110 may comprise a table leg and a wall mounting unit.

In operation, the drying rack 108 is pulled out and at least one item 140 is placed on the drying rack 108 to be dried, warmed, or dried and warmed. The drying and warming apparatus 100 is activated and the at least one item 140 is dried, warmed, or dried and warmed. After operation of the apparatus is complete, the drying rack 108 is pulled out and the at least one item 140 is removed.

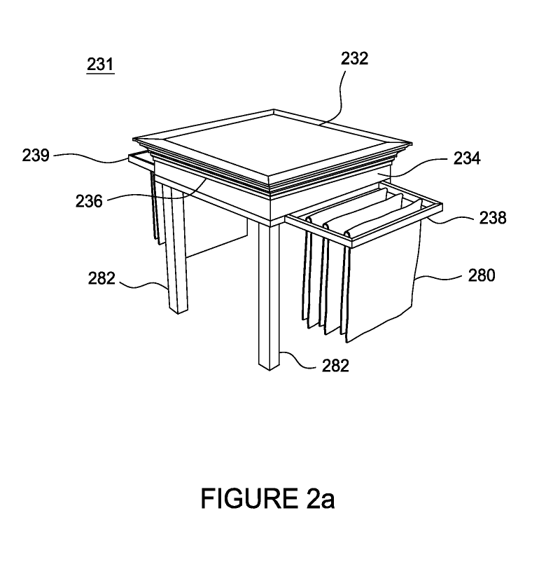

FIG. 2 illustrates a perspective front view of a drying and warming apparatus 200 including an open drying rack 208 in accordance with one embodiment of the present invention. In one embodiment of the present invention, the apparatus 200 comprises a table top 202, at least one opening 206, a casing 204, a drying rack 208, a fan assembly 214, and at least one support member 210.

In accordance with one embodiment of the present invention, the drying rack 208 may comprise a frame 213 and at least one drying rod 216 transversely secured within the frame 213 and a handle 212 for opening the drying rack 208. The handle 212 may comprise any suitable material, for example, rope, leather, wood, metal, plastic, and the like. In another embodiment of the present invention, the handle 212 may be positioned substantially within any location on the drying rack 208. In yet another embodiment of the present invention, the handle 212 may be used to support the weight of the table top 202, the casing 204, the fan assembly 214, the rack 208, and the at least one support member 210. In one embodiment of the present invention, the drying rack is adjacent the bottom portion of the casing 204. The at least one drying rod 216 may be of any size or shape. The at least one drying rod 216 may be positioned substantially in any angle in relation to the drying rack 208 to facilitate the drying of or warming of items 240. The items 240 may be positioned substantially over the at least one drying rod 216 for purposes of drying or warming. The drying rod 216 may comprise any suitable material such as wood, plastic, metal, synthetic materials, glass, natural stone, marble, concrete, granite, bamboo, and the like. In another embodiment of the present invention, the at least one drying rod 216 may contain at least one heating element (not shown). The at least one drying rod 216 may be detachably attached to the frame 213 for cleaning purposes.

In another embodiment of the present invention, the drying rack 208 may comprise at least two drawer track assemblies, each assembly comprising at least first and second members, the first member attachable to drying rack and the second member supportable substantially below the casing, wherein the second member is engaged with the first member for supporting the drying rack and for sliding movement relative to the first member, the assemblies useable to support the drying rack on opposite sides thereof (not shown). In another embodiment of the present invention, a light (not pictured) for indicating the operating status of the fan assembly 214 or a heating element (not pictured) may be attached to any section of the drying and warming apparatus, such as the table top 202. In accordance with another embodiment, a display light (not pictured) for providing light below the drying rack 208 may be attached to any section of the drying and warming apparatus, such as the table top 202.

In operation, in one embodiment of the present invention, the drying rack 208 is opened and items 240 are placed on the at least one drying rod 216. The drying rack 208 is then closed and the fan assembly 214 is activated. Before, during, and after the drying process, the table top 202 may be used to store items or function as a conventional table. After the items 240 are dry, the drying rack 208 is opened and the items 240 are removed from the drying rod 216. The drying rack 208 is then closed.

FIG. 2a illustrates a perspective front view of a drying and warming apparatus 231 including two open drying racks 238, 239 in accordance with one embodiment of the present invention. In accordance with one embodiment of the present invention, the apparatus 231 includes a table top 232, a casing 234, at least one opening 236, a first drying rack 238, a second drying rack 239, and at least one support member 282.

The table top 232, casing 234, items 280, at least one support member 282 and at least one opening 236 are similar to those which are described in FIG. 2. However, in accordance with another embodiment of the present invention, the first drying rack 238 and the second drying rack 289 are coupled to drawer track assemblies (not pictured) forming a split configuration for allowing access to the first drying rack 238 and the second drying rack 239 at opposing sides of the drying and warming apparatus 231. Although two drying racks are depicted in FIG. 2a, any number of drying racks may be used in accordance with any embodiment of the present invention.

FIG. 3 illustrates an exploded view of a drying and warming apparatus 300 in accordance with another embodiment of the present invention. In one embodiment of the present invention, the apparatus 300 comprises a table top 302, a motor 322, a power supply unit 324, a fan assembly 314, a casing 304, at least one opening 306, a drying rack 308, at least one drying rod 316, a handle 312, a control unit 320, a controller 318, and at least one leg support 310. Although depicted as comprising a table in FIG. 3, in alternative embodiments the drying and warming apparatus 300 may form any type of furniture, for example, a pub table, dining table, billiard table, Murphy table, writing desk, bedside table, bistro table, card table, coffee table, console, davenport desk, dressing table, end table, escritoire, gateleg table, night table, occasional table, Pembroke table, roll-table top desk, tea table, trestle table, vanity table, work table, shelving unit, book case, counter, chair, dresser, armoire, bureau, bed, couch, loveseat, ottoman, and the like.

In one embodiment of the present invention, the drying and warming apparatus 300 comprises a table top 302, a casing 304, a drying rack 308, a fan assembly 314, and at least one support member 310. The dimensions of the drying and warming apparatus 300 may comprise any size and shape. In an alternative embodiment of the present invention, the apparatus 300 may comprise any of the following horizontal length and width dimensions: 36″×36,″ 30″×18,″ 30″×10,″ 24″×12,″ and 24″×18.″ In accordance with one embodiment of the present invention, the table top 302, the casing 304, and the at least one support member 310 may comprise substantially the same material, wherein the material may be opaque for purposes of covering the fan assembly 314.

In one embodiment of the present invention, the table top 302 has a substantially horizontal planar surface, a top side 303, and a bottom side 305. The substantially horizontal planar surface may be parallel, for example, to a ground surface, a horizon line, or any other fixed or variable substantially horizontal plane. Although depicted in a rectangular shape, the table top 302, may comprise any surface capable of accepting items and may have any shape and size. For example, the shape of the table top 302 may be a parallelogram, a triangle, a circle, an oval, an ellipse, and the like. In accordance with one embodiment of the present invention, the table top 302 may have sufficient thickness for allowing the table top 302 to accept items. In alternative embodiments of the present invention, the table top 302 may be removably attached or permanently attached to the casing 304. The table top 302 may be of sufficient size to cover the casing 304 so that items may not be dropped into the fan assembly 314 from above. The table top 302 may comprise, for example, any suitable material such as wood, plastic, metal, synthetic materials, glass, natural stone, marble, granite, bamboo, and the like. In accordance with other embodiments of the present invention, a portion of the table top 302 may be removed (see FIG. 7), raised (see FIG. 8), or tilted upward (see FIG. 9). In one embodiment of the present invention, the table top 302 may comprise the same material as the casing 304, wherein the material comprises any level of transparency from opaque to completely transparent. In accordance with another embodiment of the present invention, the table top 302 may further comprise an opening (not pictured) for receiving a picture, logo, text, or advertisement message.

In many embodiments of the present invention, the fan assembly 314 is in a substantially horizontal plane to the bottom side 305 of the table top 302 and adjacent the bottom side 305. In one embodiment of the present invention, the fan assembly 314 comprises a hub 319 and blades 317 radially attached to the hub 319. In accordance with one embodiment of the present invention, each of the blades 317 comprises the same material, for example, wood, plastic, synthetic material, and the like. The fan assembly 314 is positioned substantially within the casing 304. In one embodiment of the present invention, the fan assembly 314 may be positioned substantially in the center of the casing 304 facing the drying rack 308. In another embodiment of the present invention, the fan assembly 314 may be positioned substantially in any location within the casing 304 provided the blades 317 are unobstructed. The fan assembly 314 can be any type of fan assembly, for example, an axial fan assembly, a mixed flow fan assembly, a cross flow fan assembly, and the like. The noise characteristics of the fan assembly 314 may be modeled, and the speed of the fan assembly 314 may be adjusted with the use of a control unit 320 to produce a desired speed and noise spectrum. The speed of the fan assembly 314 may be adjusted to any speed sufficient to dry items. The fan assembly may be directly coupled to a motor 322 and a power supply 324. In one embodiment of the present invention, the fan assembly 314 may be removably attached to the bottom side of the table top 302. In another embodiment of the present invention, the fan assembly 314 may be permanently attached to the table top 302. In alternative embodiments of the present invention, the fan assembly 314 may be attached to the table top 302, the casing 304, or both.

In accordance with one embodiment of the present invention, the casing 304 comprises a top portion 307 attached to the bottom side 305 of the table top 302, a bottom portion 309 remote from the top portion 307 and a wall 301 vertically extending between the top and bottom portions. In one embodiment of the present invention, the casing 304 is arranged substantially perpendicular to the table top 302 and extending downwardly from the bottom side 305 of the table top to substantially encase the fan assembly 314. In an alternative embodiment of the present invention, the table top 302 and the casing 304 may completely encase the fan assembly 314. The casing 304 may have at least one opening 306 on a horizontal plane to the fan assembly 314 above the fan assembly and below the assembly. In an alternative embodiment of the present invention, the casing 304 may have at least one opening 306 of any shape in any location on any plane to the fan assembly. In an alternative embodiment, the casing 304 may have a grate (not pictured) attached transversely on top portion 307 or the bottom side 309 of the wall 301 to keep foreign objects out of the fan, such as fingers, instruments, or tools. In an alternative embodiment, a grate (not pictured) may be attached transversely to the at least one opening 306. The casing 304 may comprise for example, any suitable material such as wood, plastic, metal, synthetic materials, glass, natural stone, marble, granite, bamboo, and the like. In one embodiment of the present invention, the casing 304 may further comprise a material of sufficient strength to support the weight of a fan assembly 314 and a table top 302. The casing 304 may further comprise at least one opening 306 for providing air intake, the at least one opening 306 positioned toward the top portion of the casing where the casing is attached to the bottom side 305 of the table top 302. In one embodiment of the present invention, casing 304 may be detachably attached to the drying and warming apparatus 300 for allowing access to the fan assembly 314 for cleaning. The casing 304 may have sufficient size to cover the drying rack 308.

In accordance with one embodiment of the present invention, the drying rack 308 may comprise a frame and at least one drying rod 316 transversely secured within the frame and a handle 312 for opening the drying rack 308. The handle 312 may comprise any suitable material, for example, rope, leather, wood, metal, plastic, and the like. In an alternative embodiment of the present invention, the handle 312 may be positioned substantially within any location on the drying rack 308. In yet another embodiment of the present invention, the handle 312 may be used to support the weight of the table top 302, the casing 304, at least one opening 306, the fan assembly 314, the rack 308, and the at least one support member 310.

In another embodiment of the present invention, a dryer sheet acceptor (not pictured) may be substantially positioned on the table top 302, the casing 304, or the drying rack 308. The dryer sheet acceptor (not pictured) may have any size and shape compatible with any of the embodiments of the present invention. In operation, a user may insert dryer sheets into the apparatus 300 in order to soften and improve the scent of items and then remove the dryer sheets after the items are dry.

In many embodiments of the present invention, the drying rack 308, the casing 304, and the table top 302 may be supported by the at least one support member 310. In many embodiments of the present invention, the at least one support member 310 may comprise at least one table leg of any size or shape. In another embodiment of the present invention, the table leg is attached to the casing 304. The at least one support member 310 may be made of material sufficient to support the weight of the drying rack 308, the casing 304, and the table top 302. The at least one support member 310 may comprise, for example, wood, plastic, metal, synthetic materials, glass, natural stone, marble, granite, bamboo, and the like. The at least one support member 310 is positioned substantially below the drying rack 308, and may be mounted to at least one of the drying rack 308, the casing 304, and the table top 302. In accordance with another embodiment of the present invention, the at least one support member 310 may be detachably attached to at least one of the drying rack 308, the casing 304, and the table top 302. In another embodiment of the present invention, the at least one support member 310 may comprise a wall mounting unit attached to the casing. In yet another embodiment of the present invention, the at least one support member 310 may comprise a table leg and a wall mounting unit.

The motor 322 may comprise any type of motor sufficient to operate a fan assembly 314. The motor may be positioned substantially within the casing 304. The motor 322 may comprise, for example, a single phase motor, a dual phase motor with splitting capacitor, a three phase motor, a DC motor, and the like. The motor 322 may be coupled on one end to a power supply unit 324 for providing power to the motor 322. The motor 322 may be coupled to the fan assembly 314 for rotating the fan assembly. The motor may be mounted on the table top 302 or to the casing 304. The power supply unit 324 may supply sufficient power so the motor 322 may run the fan assembly 314 at a sufficient speed to dry items in a specified time. In one embodiment of the present invention, the power supply unit may also supply power to a heating element 311. In an alternative embodiment of the present invention, a second power supply (not shown) may supply power to the heating element 311.

The power supply 324 unit may comprise, for example, a battery power supply, a linear power supply, an AC/DC supply, a switched-mode power supply, a programmable power supply, an uninterruptible power supply, a high-voltage power supply, or a voltage multiplier. The power supply may be powered by any power source, for example, electrical power, mechanical power, wind power, hydro power, solar power, and the like. The power supply 324 unit may be positioned substantially within the casing 304. In another embodiment of the present invention, the power supply unit 324 may be mounted to bottom side 305 of the table top 302 or attached to the casing 304. The power supply 324 unit may be operated by a control unit 320 and a controller 318 for accepting user input. In one embodiment of the present invention, the control unit 320 and controller 318 may be a remote device, for example, a remote control. In one embodiment of the present invention, a ground fault circuit interrupter (GFCI) (not pictured) is positioned substantially within the casing 304. In another embodiment of the present invention, the power supply may be coupled with an automatic stopping mechanism (not pictured) configured to stop the power supply for safety reasons, such as tipping over.

In one embodiment of the present invention, the heating element 311 is positioned adjacent the fan assembly 314 substantially within the casing and above the drying rack 308. The heating element 311 may comprise any source of heat including radiant heat, convection heat, and the like. The heating element 311 may be configured to supply sufficient heat to dry items. With the addition of a heating element 311, the drying table can also act as a towel warmer. The heating element 311 may be of any size or shape. In other embodiments of the present invention, the heating element 311 may comprise one or more of a band heater, cartridge heater, tubular element heater, immersion heater, circulation heater, cast aluminum heater, silicone rubber heater, silicon carbide element heater, molybdenum disilicide heater, enclosure heater, ceramic heater, metallic element heater, element and rod heater, mica element heater, bundle rod heater, coil heater, rod over bend element heater, strip element heater, porcupine element heater, plug heater, and folded ribbon element heater. In another embodiment of the present invention, the heating element 311 may be removably attached to the bottom side of the table top. In another embodiment of the present invention, the heating element 311 may be removably attached to the casing 304. In yet another embodiment of the present invention a heating element may be positioned within at least one drying rod 316. Although one heating element 311 is depicted in FIG. 3, in accordance with alternate embodiments of the present invention, any number and combination of heating elements may be used and positioned in any location below the table top 302. In yet another embodiment of the present invention, a heating element 311 may be positioned substantially within the drying rack 304 and within at least one drying rod 316.

In operation, in one embodiment of the present invention, the drying rack 308 is opened and items (see FIG. 2) are placed on the at least one drying rod 316. The drying rack 308 is then closed and the fan assembly 314 is activated using the control unit 320. Before, during, and after the drying process, the table top 302 may be used to store items or function as a table or shelf. After the items (see FIG. 2) are dry, the drying rack 308 is opened and they are removed from the drying rod 316. The drying rack 308 is then closed. In one embodiment of the present invention, the control unit 320 may be used to control heat, drying time, opening of the drying rack 308, fan assembly 314 speed, and the like.

In accordance with one embodiment of the present invention, the control unit 320 may be coupled with a controller 318 for accepting user input. In accordance with one embodiment of the present invention, the controller 318 may comprise a user interface. For example, the controller 318 may include: graphical controllers (GUI), web-based controllers or web controllers (WUI), command line interfaces, tactile interfaces, touchscreen controllers, gesture interfaces, intelligent controllers, motion tracking interfaces, tangible controllers, text controllers, voice controllers, natural-language interfaces, zero-input interfaces, physical interfaces, switch interfaces, knob interfaces, button interfaces, toggle on/off interfaces, dial timer interfaces and the like. In one embodiment of the present invention, the fan assembly and heating element may be independently controlled with toggle on/off switches and a timer dial. The control unit 320 takes input commands from the controller 318 and executes them on the device. In one embodiment of the present invention, the input commands relate to temperature, drying time, warming time, opening of the drying rack 308, and fan assembly 314 speed. The control unit 320 may include a timer (not pictured). The control unit 320 may be positioned at any location adjacent the drying and warming apparatus 300, for example, by way of permanent or temporary attachment to the table top 302, the casing 304, the drying rack 308, or the least one leg support 310.

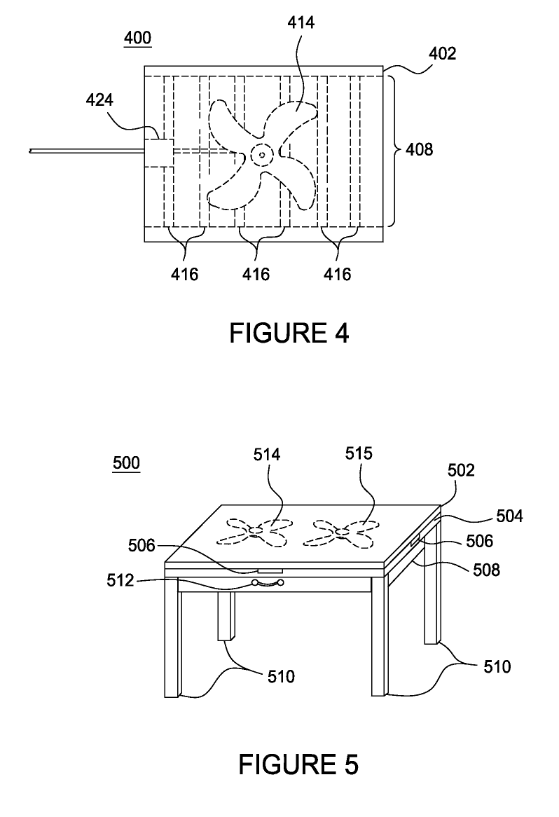

FIG. 4 illustrates a top view of a drying and warming apparatus 400 in accordance with another embodiment of the present invention. In one embodiment of the present invention, the apparatus 400 comprises a table top 402, a drying rack 408, a fan assembly 414, a power supply 424, and at least one drying rod 416.

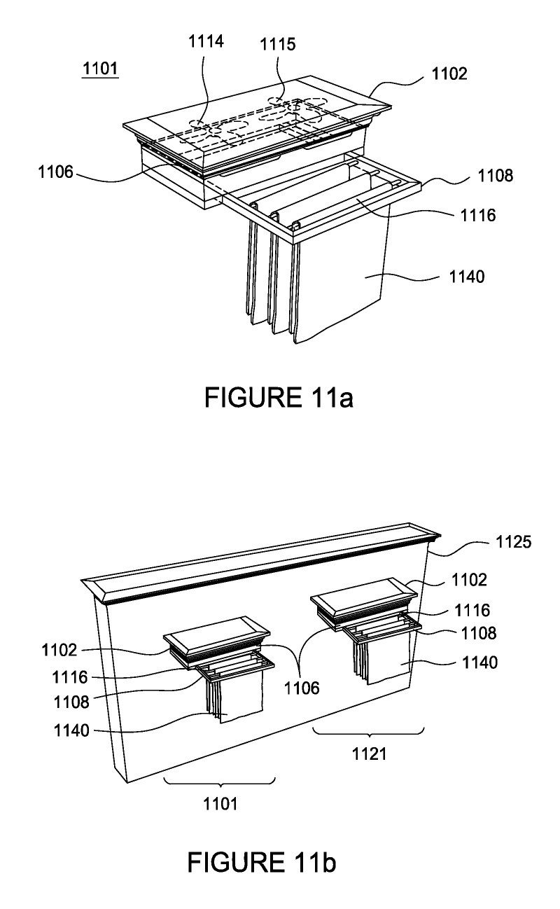

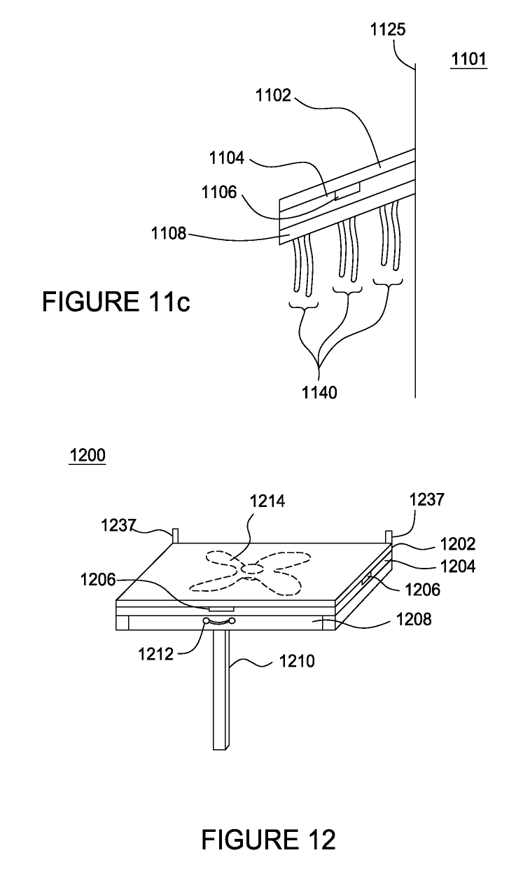

FIG. 5 illustrates a perspective front view of a drying and warming apparatus 500 including at least two fan assemblies 514, 515 in accordance with another embodiment of the present invention. In one embodiment of the present invention, the apparatus 500 comprises a table top 502, a casing 504, a drying rack 508, a fan assembly 514, a second fan assembly 515, a handle 512, at least one opening 506, and at least one support member 510. Although two fan assemblies 514, 515 are depicted in FIG. 5, any number of fan assemblies may be included in accordance with any embodiment of the present invention, such as that in FIG. 11. For example, any embodiment of the present invention may comprise one, two, three, four, or more fans. In operation, all fans may be configured to run together or one by one as selected by a controller (see FIG. 3).

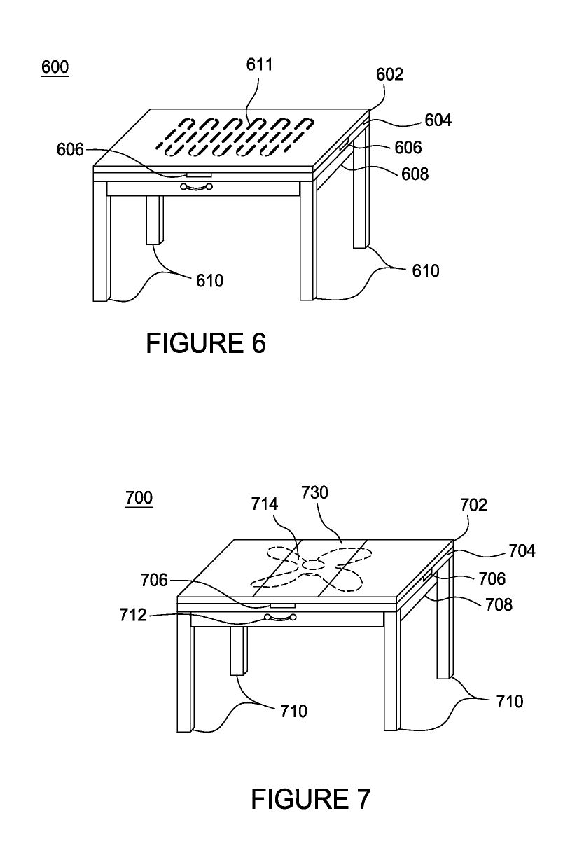

FIG. 6 illustrates a perspective front view of a drying and warming apparatus 600 including a heating element 611 in accordance with another embodiment of the present invention. In one embodiment of the present invention, the apparatus 600 comprises a table top 602, a casing 604, a drying rack 608, a heating element 611, at least one opening 606, and at least one support member 610. In another embodiment of the present invention, the apparatus may comprise a heating element 611 and not a fan assembly. In accordance with other embodiments of the present invention, the apparatus 600 may comprise one or more fans and one or more heating elements. In accordance with another embodiment of the present invention, the apparatus 600 may comprise more than one heating element 611 and no fan assemblies. In operation, the heating element may be configured to run together with a fan assembly or one by one as selected by a controller (see FIG. 3). The heating time, intensity, and temperature may be selected by the controller (see FIG. 3).

FIG. 7 illustrates a perspective front view of a drying and warming apparatus 700 including a fan assembly unit and a removable table top panel 730. In one embodiment of the present invention, the apparatus 700 comprises a table top 702, a casing 704, a drying rack 708, a fan assembly 714, a handle 712, at least one opening 706, at least one support member 710, and a removable table top panel 730.

The table top 702 is similar to that which is described in FIG. 1. However, according to an alternative embodiment, the table top 702 comprises a removable table top panel 730. The removable table top panel 730 may be of any size or shape. The removable table top panel 730 may be detachably secured to the table top 702 or the casing 704. In one embodiment of the present invention, the removable table top panel 730 may comprise any sized portion of the table top 702. In another embodiment of the present invention, removable table top panel 730 may comprise the same material as the table top 702. The removable table top panel 730 may be removed by hand or removed by a removal device (not shown). In one embodiment of the present invention, the removable table top panel 730 is of sufficient size that, when removed, an aperture is created in the table top 702 of at least adequate size for providing ample air intake to the fan assembly 714.

In operation, in one embodiment of the present invention, the drying rack 708 is opened and items (see FIG. 2) are placed on the at least one drying rod (see FIG. 2). The removable table top panel 730 is then removed. The drying rack 708 is closed and the fan assembly 714 is activated. Before, during, and after the drying process, the table top 702 may be used to store items or function as a table. After the items (see FIG. 2) are dry, the drying rack 708 is opened, and the items (see FIG. 2) are removed from the drying rod (see FIG. 2). The drying rack 708 is then closed and the removable table top panel is replaced on the table top 702.

FIG. 8 illustrates a perspective front view of a drying and warming apparatus 800 including an extendable table top 802 in accordance with another embodiment of the present invention. In one embodiment of the present invention, the apparatus 800 comprises a table top 802, a casing 804, a drying rack 808, a hidden fan assembly 814, a handle 812, at least one support member 810, and at least one table top support member 831.

In accordance with one embodiment of the present invention, at least one table top support member 831 may comprise at least one rod for lifting the table top 802, attached to the at least one support member 810. The table top 802 may be raised by the at least one table top support member 831 to allow sufficient air flow to enter the fan assembly 814. The table top 802 may be lifted manually or with the use of mechanical, electrical, wind, or hydraulic energy. The at least one table top support member 831 may be locked in an open position for suspending the table top 802 at a selectable distance above the fan assembly 814. In accordance with one embodiment of the present invention, a casing (not shown) may sufficiently cover the fan assembly 814 for blocking it from sight. In accordance with one embodiment of the present invention, the top support member 831 may comprise any material suitable for supporting the table top 802. In accordance with another embodiment of the present invention, the at least one support member may be height-adjustable, for example, by a telescoping leg assembly.

In operation, in one embodiment of the present invention, the drying rack 808 is opened and items (see FIG. 2) are placed on the at least one drying rod 816. The drying rack 808 is then closed, the at least one table top support member 831 may be raised, and the fan assembly 814 is activated. Before, during, and after the drying process, the table top 802 may be used to store items or function as a table. After the items (see FIG. 2) are dry, the drying rack 808 is opened they are removed from the drying rod 816. The drying rack 808 is then closed and the table top support member 831 is lowered.

FIG. 9 illustrates a perspective front view of a drying and warming apparatus 900 including a tiltable table section 932 in accordance with another embodiment of the present invention. In one embodiment of the present invention, the apparatus 900 comprises a table top 902, a casing 904, a drying rack 908, a hidden fan assembly 914, a handle 912, at least one opening 906, at least one support member 910, and the tiltable table section 932.

The table top 902 is similar to that which is described in FIGS. 1-3. In accordance with one embodiment of the present invention, the tiltable table section 932 may comprise the same material as the table top 902. The tiltable table section 932 may be attached to the table top 902 with a hinge. In accordance with one embodiment of the present invention, the tiltable table section 932 may be locked in an open position creating an aperture of sufficient size to allow ample air intake for the fan assembly 914. Dowels or support rods (not shown) may be attached to the casing for supporting the tiltable table section 932 in a locked open position. The tiltable table section 932 may be closed to form a single plane with the table top 902. In accordance with one embodiment of the present invention, the tiltable table section 932 may be tilted by hand or with a tilting device (not shown). Tiltable table section 932 may be positioned on any portion of the table top 902 and comprise any size or shape. The tiltable table section 932 may be positioned adjacent to the table top 902 and substantially above the casing 904.

In operation, in one embodiment of the present invention, the drying rack 908 is opened and items (see FIG. 2) are placed on the at least one drying rod 916. The drying rack 908 is then closed, the tiltable table section 932 is locked in an open position, and the fan assembly 914 is activated. Before, during, and after the drying process, the table top 902 may be used to store items or function as a table. After the items are dry, the drying rack 908 is opened and the items are removed from the drying rod. The drying rack 908 and the tiltable table section 932 are then closed.

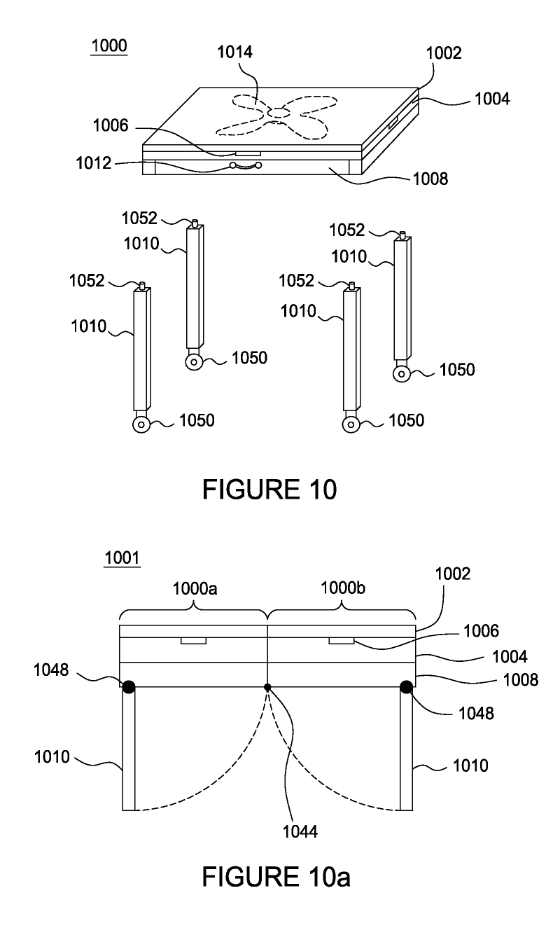

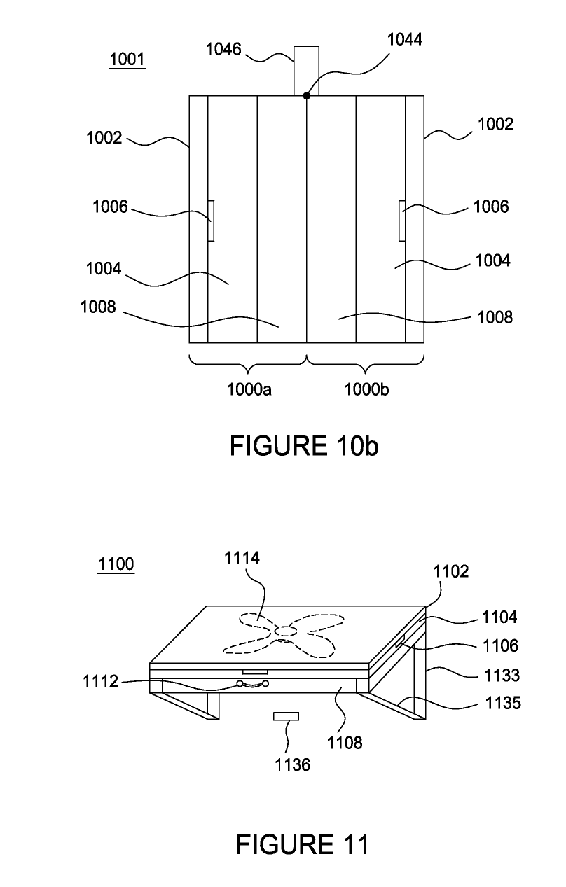

FIG. 10 illustrates a perspective front view of a drying and warming apparatus 1000 including detachable support members 1010 in accordance with another embodiment of the present invention. In one embodiment of the present invention, the apparatus 1000 comprises a table top 1002, a casing 1004, a drying rack 1008, a fan assembly 1014, a handle 1012, at least one opening 1006, at least one support member 1010.

The at least one support member 1010 is similar to that which is described in FIG. 1. However, according to an alternative embodiment, the at least one support member 1010 comprises a fastening unit 1052 and wheels 1050. In accordance with one embodiment of the present invention, the drying rack 1008, the casing 1004, and the table top 1002 may be supported by the at least one support member 1010. The at least one support member 1010 may comprise at least one leg of any size and shape. The at least one support member 1010 may be detachably attached to at least one of the table top 1002, the casing 1004, and the drying rack 1008 with the fastening unit 1052. In accordance with one embodiment of the present invention, the fastening unit 1052 may comprise any material sufficient to attach the at least one support member 1010. The at least one support member 1010 may be made of material sufficient to support the weight of the drying rack 1008, the casing 1004, and the table top 1002. The at least one support member 1010 may comprise, for example, wood, plastic, metal, synthetic materials, glass, natural stone, marble, concrete, granite, bamboo, and the like. When the at least one support member 1010 is removed with the fastening unit 1052, the entire apparatus 1000 is capable of being portable. In alternative embodiments of the present invention, the at least one support member 1010 may be collapsible to allow the entire apparatus 1000 to be portable. The at least one support member 1010 may be collapsible, for example, with a hinge located at the top of the at least one support member.

The at least one support member 1010 is positioned substantially below the drying rack 1008, and may be mounted to at least one of the drying rack 1008, the casing 1004, and the table top 1002. In accordance with another embodiment of the present invention, the at least one support member may be removed and stored in a chamber (not pictured) substantially below the table top 1002. In this embodiment, the table top 1002 may open in a suitcase fashion to expose a chamber (not pictured) for accepting the at least one support member. In accordance with another embodiment of the present invention, at least one wheel assembly 1050 may be detachably attached to the bottom of the at least one support member 1010. The wheel assembly 1050 may comprise any type of wheel assembly capable of supporting the weight of the drying and warming apparatus 1000. The wheel assembly 1050 may comprise a material that would not scratch typical flooring such as hardwood, laminate, tile, and the like. For example, the wheel assembly 1050 may substantially comprise rubber or silicone. The wheel assembly 1050 allows the entire apparatus 1000 to be moved around without being carried.

FIG. 10a illustrates a perspective side view of a drying and warming apparatus 1001 including two foldable sections 1000a, 1000b in an open position in accordance with another embodiment of the present invention. In one embodiment of the present invention, the drying and warming apparatus 1001 comprises a table top 1002, a casing 1004, a drying rack 1008, at least one opening 1006, at least one support member 1010, a center hinge 1044, a support hinge 1048, a first side 1000a and a second side 1000b.

In accordance with one embodiment of the present disclosure, the table top 1002, the casing 1004, the drying rack 1008, the at least one opening 1006, and the at least one support member 1010 are similar to those which are described in FIG. 10. In an alternative embodiment of the present invention, the drying and warming apparatus 1001 may be separated into at least a first side 1000a and a second side 1000b of equal or differing proportions. The sides 1000a, 1000b, may be separated with a fissure between them. The fissure may be centered or on any location on or at a substantially vertical plane through the apparatus. The first side 1000a and second side 1000b may have inner portions. The inner portions may run the entire height of the apparatus along the fissure. In operation, the sides 1000a, 1000b may be releasably locked together in an open position to form a table or shelf in accordance with any embodiment of the present disclosure. The apparatus 1001 may be locked and maintained in an open position with at least a first lock (not shown) in a substantially horizontal plane that may be parallel, for example, to a ground surface, a horizon line, or any other fixed or variable substantially horizontal plan. When the apparatus 1001 is generally in the open position, the inner portion of the first side 1000a may be juxtaposed the inner portion of the second side 1000b. The first and second side 1000a, 1000b may generally also be foldable about a center hinge 1044 and closed to form a portable structure. The apparatus 1001 may be closed and maintained or locked in the closed position by at least a second lock. When the apparatus 1001 is in the closed position, the inner portion of the first side 1000a may be substantially parallel with the inner portion of the second side 1000b. The apparatus 1001 may be closed, for example, to form a typical suitcase configuration. The center hinge 1044 may generally located in any location between the sides so that both sides are connected and closeable. For example, the center hinge 1044 may be located at the top or the bottom of the fissure between the sides 1000a, 1000b. The at least one support member 1010 may be folded down via a support hinge 1048 under each side 1000a, 1000b. In an alternative embodiment, the at least one support member 1010 may be removed and stored within the underside of each side 1000a, 1000b between drying rods (not shown). In accordance with alternative embodiments of the present invention, the table top may be of any size, for example 30″×30″. In another embodiment of the present invention, the casing may be any height, for example 5″.

FIG. 10b illustrates a perspective side view of the drying and warming apparatus of FIG. 10a, including two foldable sections in a closed position. In one embodiment of the present invention, the apparatus 1001 comprises a table top 1002, a casing 1004, a drying rack 1008, at least one opening 1006, at least one support member (not shown), a center hinge 1044, a handle 1046, a first side 1000a, and a second side 1000b.

In accordance with one embodiment of the present disclosure, the table top 1002, the casing 1004, the drying rack 1008, the at least one opening 1006, and the center hinge 1044 are similar to those which are described in FIG. 10a. In accordance with another embodiment of the present invention, the sides 1000a, 1000b may be releasably locked together in a closed position to enable portability of the drying and warming apparatus 1001. A handle 1046 may generally be attached to a top side of the closed apparatus. In an alternative embodiment of the present invention, the handle 1046 may be detachable. In accordance with any embodiments of the present invention, one or more fan assemblies (not shown) or drying racks 1008 may be attached to each side 1000a, 1000b of the drying and warming apparatus. In accordance with another embodiment of the present invention, the dimensions of the drying and warming apparatus 1001 when it is in its closed position could be any height, width, and depth. For example, the drying and warming apparatus 1001 may be 15″×30″×10″. The entire drying and warming apparatus 1001 may be carried from one location to another location, such as a vacation home, hotel room or rental unit.

FIG. 11 illustrates a perspective front view of a drying and warming apparatus 1100 attachable to a wall in accordance with another embodiment of the present invention. In one embodiment of the present invention, the apparatus 1100 comprises a table top 1102, a casing 1104, a drying rack 1108, a fan assembly 1114, a handle 1112, at least one opening 1106, a latch 1136, a secondary support member 1135, at least one wall support member 1133.

In accordance with one embodiment of the present invention, the drying rack 1108, the casing 1104, and the table top 1102 may be supported by a wall support member 1133 for securing the apparatus 1100 to a wall surface. In one embodiment of the present invention, the wall support member 1133 may comprise a hinge so the apparatus 1100 may be collapsible. In accordance with alternative embodiments of the present invention, the apparatus 1100 a power supply (not shown) may be outside of a wall or integrated inside, or hard-wired, in the wall and coupled with the apparatus 1100. In another embodiment of the present invention, a latch 1136 substantially perpendicular to the drying rack 1108 on the wall surface at a height wherein the latch 1136 couples to a bottom side of the drying rack 1108 and secures the table top 1102, the housing 1104, and the drying rack 1108, in a folded position substantially perpendicular to the ground. The wall support member 1133 may be made of material sufficient to support the weight of the drying rack 1108, the casing 1104, and the table top 1102. The wall support member 1133 may comprise, for example, wood, plastic, metal, synthetic materials, glass, natural stone, marble, concrete, granite, bamboo, and the like. The wall support member 1133 is positioned substantially adjacent to the drying rack 1108, and may be mounted to at least one of the drying rack 1108, the casing 1104, and the table top 1102. In accordance with another embodiment of the present invention, the wall support member 1133 may be detachably attached to at least one of the drying rack 1108, the casing 1104, and the table top 1102. In accordance with another embodiment of the present invention, the apparatus 1100 may further comprise a secondary support member 1135 for providing additional support to the wall support member 1133 attached at a proximate end to the table top 1102 and at a distal end to the wall support member 1133. The secondary support unit 1135 may comprise any material capable of providing secondary support to the wall support member 1133. For example, the secondary support 1135 unit may be a flexible strap or a metal member comprising a hinge positioned in the center of the secondary support unit 1135 between the proximate and distal ends. In accordance with one embodiment of the present invention, the drying and warming apparatus 1100 may be utilized, for example, as any type of shelf unit.

FIG. 11a illustrates a perspective front view of a drying and warming apparatus 1101 attachable to a wall in accordance with another embodiment of the present invention. In one embodiment of the present invention, the apparatus 1101 comprises a table top 1102, a drying rack 1108, at least one drying rod 1116, two fan assemblies 1114, 1115, at least one opening 1106, and at least one wall support member (not shown).

The table top 1102, drying rack 1108, and the at least one opening 1106 are similar to those which are described in FIG. 11. The at least one drying rod 1116 and the items 1140 are similar to that which are depicted in FIG. 2. The fan assemblies 1114, 1115 are similar to those which are depicted in FIG. 5. In accordance with another embodiment of the present invention, the wall support member (not shown) is located where the apparatus 1101 meets the wall and is substantially hidden from view. The wall support member (not shown) may comprise, for example, one or more keyhole assemblies containing a keyhole-shaped aperture and a key being configured and dimensioned to fit into the keyhole slot. In alternative embodiments of the present invention, the wall support member (not shown) may comprise any means suitable for securing the apparatus 1101 to a wall. Although two fan assemblies are depicted in FIG. 11a, any number of fan assemblies may be used in accordance with any embodiment of the present invention.

FIG. 11b illustrates a perspective front view of two drying and warming apparatus 1101 and 1121, attachable to a wall in accordance with another embodiment of the present invention. In one embodiment of the present invention, the apparatus 1101, 1121 comprise a table top 1102, a drying rack 1108, at least one drying rod 1116, at least one opening 1106, and at least one wall support member (not shown).

The table top 1102, items 1140, at least one drying rod 1116, drying rack 1108, at least one wall support member (not shown), and at least one opening 1106 are similar to those which are described in FIG. 11a. In accordance with another embodiment of the present invention, the apparatus 1101, 1121 are attached to a wall 1125. The wall may comprise any material suitable for supporting the weight of a drying and warming apparatus 1100 and items (not shown) placed thereon. The wall may comprise, for example, wood, plastic, metal, synthetic materials, glass, natural stone, marble, concrete, granite, bamboo, sheet rock, tile, paneling, and the like.

FIG. 11c illustrates a perspective side view of a drying and warming apparatus attachable to a wall structure in accordance with another embodiment of the present invention. In accordance with one embodiment of the present invention, the drying and warming apparatus 1101 comprises a table top 1102, items 1140, a drying rack 1108, at least one opening 1106, and a casing 1104.

In accordance with alternative embodiments of the present disclosure, the table top 1102, drying rack 1108, opening 1106, items 1140, and casing 1104 are similar to those which are described in FIG. 11 and attached to a wall 1125. The items 1140 are in accordance with those which are described in FIGS. 11a and 11b. In addition, the drying apparatus 1101 may be attached to the wall 1125 on any angle normal to the plane formed by the wall 1125.

FIG. 12 illustrates a perspective front view of a drying and warming apparatus 1200 attachable to a wall and supportable by a support member 1210 and a wall support member 1237 in accordance with another embodiment of the present invention. In one embodiment of the present invention, the apparatus 1200 comprises a table top 1202, a casing 1204, a plurality of openings 1206, a drying rack 1208, a handle 1212, and at least one support member 1210. The drying and warming apparatus 1200 may take the form of any type of table, for example, a pub table, dining table, billiard table, Murphy table, writing desk, bedside table, bistro table, card table, coffee table, console, davenport desk, dressing table, end table, escritoire, gateleg table, night table, occasional table, Pembroke table, roll-table top desk, tea table, trestle table, vanity table, work table, and the like. The dimensions of the apparatus 1200 may be of any size and shape. In one exemplary embodiment of the present invention, the apparatus 1200 may comprise any of the following horizontal length and width dimensions: 36″×36,″ 30″×28,″ 30″×20,″ 24″×22,″ and 24″×28.″ In accordance with one embodiment of the present invention, the table top 1202, the casing 1204, and the at least one support member 1210 comprise substantially the same material that may be opaque for purposes of covering the fan assembly 1214.

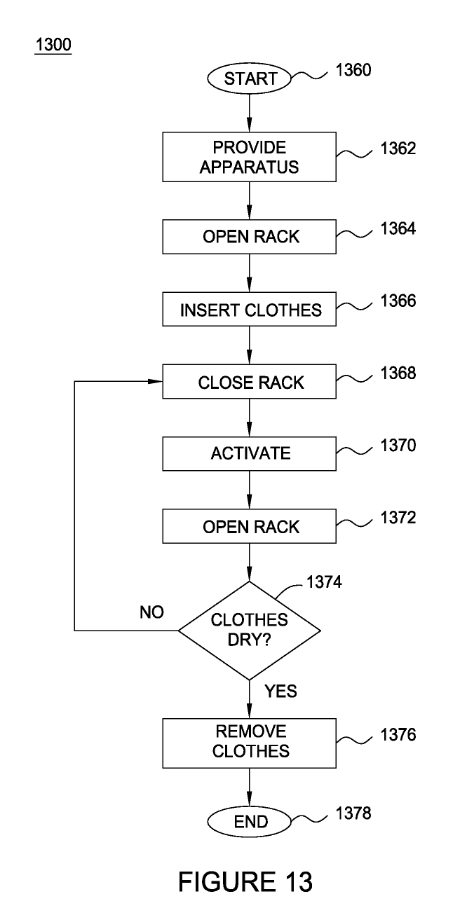

FIG. 13 illustrates a general flow chart of an exemplary method of drying items using a drying and warming apparatus in accordance with one embodiment of the present invention. The method 1300 begins at step 1360 and may use a drying and warming apparatus as described in any one of the aforementioned Figures.

At step 1362, a drying and warming apparatus in accordance with any of the embodiments described herein is provided. At step 1364, a drying rack is substantially opened to expose at least one drying rod. In one embodiment of the present invention, the drying rack and the at least one drying rod operate in accordance with any of the embodiments described herein. At step 1366, items are placed on at least one drying rod. At step 1368, the drying rack is closed. The drying rack may be closed in any manner in accordance with embodiments of the present invention described herein. At step 1370, the drying and warming apparatus is activated. The drying and warming apparatus may be activated in accordance with any of the embodiments described herein. In accordance with one embodiment of the present invention, the drying and warming apparatus may be activated, for example, with a control unit and a control unit console.

At step 1372, the drying rack is opened in a manner in accordance with any of the embodiments described herein. In an alternative embodiment, at step 1374 a moisture level of the clothing is checked. The moisture level is compared with an acceptable level of moisture according to user preference. If the moisture level is at an acceptable level, the items are removed at step 1376. In accordance with one embodiment of the present invention, the items may be removed by hand. In an alternative embodiment of the present invention, the items may be removed with a removal device. If the items are not sufficiently dry at step 1374, the method returns to step 1368. Once the items are removed at step 1376, the process completes at step 1378.

While the foregoing is directed to embodiments of the present invention, other and further embodiments of the invention may be devised without departing from the basic scope thereof. In view of the wide variety of embodiments that can be applied, it should be understood that the illustrated examples are exemplary only, and should not be taken as limiting the scope of the following claims. Further, the claims should not be read as limited to the described order or elements unless stated to that effect.

What is claimed is:

1. A drying and warming apparatus comprising:
a table top having a substantially horizontal planar surface, a top side, and a bottom side;
a fan assembly means adjacent the bottom side of the table top;
a casing comprising a top portion attached to the bottom side of the table top, a bottom portion remote from the top portion, and a wall vertically extending between the top and bottom portions, the casing arranged substantially perpendicular to the table top and extending downwardly from the bottom side of the table top to substantially encase the fan assembly means;
a drying rack adjacent the bottom portion of the casing, the drying rack comprising a frame and at least one drying rod transversely secured within the frame; and
at least one support member for supporting the table top, fan assembly, casing and drying rack.

2. The drying and warming apparatus of claim 1, wherein the shape of the table top comprises a parallelogram, a square, a triangle, a circle, an oval, or an ellipse.

3. The drying and warming apparatus of claim 1, wherein the table top is removably attachable to the casing.

4. The drying and warming apparatus of claim 1, wherein the fan assembly means is encased entirely within the table top and the casing.

5. The drying and warming apparatus of claim 1, further comprising:
a fissure separating the apparatus at a centered vertical plane into a first and a second side, the first side having an inner portion and the second side having an inner portion;
at least one center hinge attached to a bottom of the fissure, joining the inner portion of the first side with the inner portion of the second side;
a first lock for maintaining the apparatus in an open position wherein the inner portion of the first side is juxtapose the inner portion of the second side; and
a second lock for maintaining the apparatus in a closed position wherein the inner portion of the first side is substantially parallel with the inner portion of the second side.

6. The drying and warming apparatus of claim 5, wherein each of the at least one support members is foldable via a support hinge and adapted for storage within at least one side of the drying rack.

7. The drying and warming apparatus of claim 1, wherein the fan assembly means is removably attached to the bottom side of the table.

8. The drying and warming apparatus of claim 1, wherein the fan assembly means is removably attached to the casing.

9. The drying and warming apparatus of claim 1, wherein the casing further comprises at least one opening for providing air intake.

10. The drying and warming apparatus of claim 1, further comprising:
a control unit positioned adjacent the table top, the control unit comprising a controller for controlling the fan assembly means.

11. The drying and warming apparatus of claim 1, further comprising:
a heating element adjacent the fan assembly, the heating element positioned substantially within the casing and above the drying rack.

12. The drying and warming apparatus of claim 1, further comprising:
at least two drawer track assemblies, each assembly comprising at least first and second members, the first member attachable to the drying rack and the second member supportable substantially below the table top, wherein the second member is engaged with the first member for supporting the drying rack and for sliding movement relative to the first member, the assemblies supporting the drying rack on opposite sides thereof.

13. The drying and warming apparatus of claim 1, wherein the at least one support member comprises at least one table leg attached to the casing.

14. The drying and warming apparatus of claim 13, further comprising:
at least one additional support member comprising a wall mounting unit attached to the casing.

15. The drying and warming apparatus of claim 1, wherein the at least one support member comprises at least one table leg detachably attached to the casing for allowing the drying and warming apparatus to be portable.

16. The drying and warming apparatus of claim 1, wherein the at least one support member comprises a wall mounting unit attached to the casing.

17. A drying and warming apparatus comprising:
a table top having a substantially horizontal planar surface, a top side, and a bottom side;
a heating element for providing heat, the heating element adjacent the bottom side of the table top;
a casing comprising a top portion attached to the bottom side of the table top, a bottom portion remote from the top portion, and a wall vertically extending between the top and bottom portions, the casing arranged substantially perpendicular to the table top and extending downwardly from the bottom side of the table top to substantially encase the heating element;
a drying rack adjacent the bottom portion of the casing, the drying rack comprising a frame and at least one drying rod transversely secured within the frame; and
at least one support member for supporting the table top, heating element, casing and drying rack.

18. The drying and warming apparatus of claim 17, wherein the at least one heating element is removably attached to the bottom side of the table top.

19. The drying and warming apparatus of claim 17, wherein the at least one heating element is removably attached to the casing.

20. A method of drying items, comprising:
providing a drying and warming apparatus comprising:
a table top having a substantially horizontal planar surface, a table top side, and a bottom side;
a fan assembly means adjacent the bottom side of the table top;
a casing comprising a table top portion attached to the bottom side of the table top, a bottom portion remote from the table top portion, and a wall vertically extending between the table top and bottom portions, the casing arranged substantially perpendicular to the table top and extending downwardly from the bottom side of the table top to substantially encase and obscure from view the fan assembly means;
a drying rack adjacent the bottom portion of the casing, the drying rack comprising a frame and at least one drying rod transversely secured within the frame; and
at least one support member for supporting the table top, fan assembly means, casing and drying rack;
opening the drying and warming apparatus;
placing a wet item on the at least one drying rod;
closing the drying and warming apparatus;
activating the drying and warming apparatus;
waiting for the item to dry;
opening the drying and warming apparatus; and
removing the item from the rods.

21. The method of claim 20, further comprising:
checking the moisture level of the wet item.

22. A drying and warming apparatus comprising:
a table top having a substantially horizontal planar surface, a top side, and a bottom side;
a fan assembly means adjacent the bottom side of the table top;
a heating element adjacent the fan assembly positioned substantially below the fan assembly means;
a casing comprising:
a top portion attached to the bottom side of the table top;
a bottom portion remote from the top portion;
a wall vertically extending between the top and bottom portions; and
at least one opening for providing air intake, the at least one opening positioned substantially toward the top portion of the casing where the casing is attached to the bottom side of the table top, wherein the casing is arranged substantially perpendicular to the table top and extending downwardly from the bottom side of the table top to substantially encase the fan assembly means and the heating element;
a drying rack adjacent the bottom portion of the casing, the drying rack comprising a frame and at least one drying rod transversely secured within the frame;
at least two drawer track assemblies, each assembly comprising at least first and second members, the first member attachable to the drying rack and the second member supportable substantially below the casing, wherein the second member is engaged with the first member for supporting the drying rack and for sliding movement relative to the first member, the assemblies supporting the drying rack on opposite sides thereof;
a control unit positioned adjacent the table top substantially outside the table top, the control unit comprising a controller for controlling the fan assembly means and the heating element; and
at least four support members for supporting the table top, fan assembly, heating element, casing, drying rack, drawer track assemblies, and control unit.

23. The drying and warming apparatus of claim 22, further comprising:
a grate for substantially isolating the fan assembly means from foreign objects, the grate being positioned adjacent the fan assembly means.
